(19) United States
(12) Patent Application Publication
(10) Pub. No.: US 2010/0187378 A1
(43) Pub. Date: Jul. 29, 2010

(54) Visual presenter

(75) Inventors: Hiroshi Yamakose, Gifu (JP); Shinji Ono, Aichi (JP); Kenichi Maruyama, Aichi (JP)

Correspondence Address: POSZ LAW GROUP, PLC, 12040 SOUTH LAKES DRIVE, SUITE 101, RESTON, VA, 20191, US

(73) Assignee: Elmo Co., Ltd., Nagoya-shi (JP)

(21) Appl. No.: 12/588,321

(22) Filed: Oct. 13, 2009

(30) Foreign Application Priority Data
Jan. 27, 2009 (JP) 2009-014846

(51) Int. Cl. F16M 11/10

(52) U.S. Cl. 248/184.1

(57) ABSTRACT

A visual presenter includes a base, a column support including an upright part and a horizontal part, and a camera head mounted on a distal end of the horizontal part. The horizontal part includes first and second horizontal parts. The first horizontal part is mounted on a first support shaft further mounted on the upright part, so as to be pivotable between a downwardly extending position and a horizontal position. The second horizontal part is mounted on a second support shaft further mounted on an end of the first horizontal part located opposite the first support shaft side, so as to be pivotable between a horizontal backward position and a horizontal forward position.

### CROSS-REFERENCE TO RELATED APPLICATIONS

This application is based on and claims the benefit of priority from the prior Japanese Patent Application No. 2009-14846, filed on Jan. 27, 2009, the entire contents of which are incorporated herein by reference.

### BACKGROUND

1. Field

The present invention relates to a visual presenter in which a camera head is provided on a distal end of a column support standing on a base, and a material such as document or model placed in front of the base is imaged by the camera head, and an obtained-image is reproduced by a monitor television or projected on a screen by a video projector.

2. Related Art

Japanese patent application publication, JP-A-2008-193391 discloses one type of visual presenter. FIGS. 9 and 10 show the disclosed visual presenter 100. As shown, a support column 102 is mounted on a base 101 so as to stand from the base 101. The support column 102 has a distal end on which a camera head 103 is mounted.

The support column 102 of the visual presenter 100 includes an upright part 102a standing upright from the base 101 and a horizontal part 102b that is continuous from the upright part 102a and extends horizontally ahead of the base 101. The camera head 103 is mounted on the distal end of the horizontal part 102b. A material such as document is placed on an installation surface on which the visual presenter is placed, so as to come close to a front of the base 101 and is imaged by an imaging lens 104 of the camera head 103.

In the above-described visual presenter 100, a mounting 200 discrete from the visual presenter 100 is used when a material has a larger size than an imaging area of the camera head 103. In this case, the visual presenter 100 is placed on the mounting 200, and the material is then imaged by the camera head 103. An object distance from the imaging lens 104 of the camera head 103 to the material becomes longer when the mounting 200 is used than when the mounting 200 is not used. Accordingly, the imaging area 201 of the camera head 103 can be enlarged.

In the conventional visual presenter 100, however, the imaging area cannot be enlarged without use of the mounting 200 which is discrete from the visual presenter 100 and on which the visual presenter 100 needs to be placed. Thus, the conventional visual presenter 100 is not convenient for users.

Furthermore, when the visual presenter 100 is placed on the mounting 200 so that the imaging area 201 is enlarged, even a front end of the mounting 200 is included in the imaging area 201 as shown in FIG. 9, whereupon the front end of the mounting 200 is imaged by the camera head 103 together with the material. This poses a problem.

### SUMMARY

Therefore, an object of the present invention is to provide a visual presenter which can enlarge the imaging area without use of the mounting by a simple operation and has good usability.

Another object of the invention is to provide a visual presenter which can image only the material when the imaging area is enlarged, preventing anything other than the material from being imaged together with the material.

According to one aspect of the present invention, there is provided a visual presenter comprising a base; and a column support standing on the base and having a distal end on which a camera head is located, the column support including an upright part standing upright from the base and a horizontal part that is continuous from the upright part and extends horizontally ahead of the base, the distal end of the column support corresponding to a distal end of the horizontal part, the camera head being mounted on the distal end of the horizontal part and adapted to image a material placed on an installation surface for the base, wherein the horizontal part includes a first horizontal part and a second horizontal part; the first horizontal part is mounted on a first support shaft further mounted on an upper end of the upright part, so as to be pivotable between a downwardly extending position where the first horizontal part extends downward in parallel with the upright part and a horizontal position where the first horizontal part extends ahead of the base horizontally from the upright part; and the second horizontal part is mounted on a second support shaft further mounted on an end of the first horizontal part located opposite the first support shaft side, so as to be pivotable between a horizontal backward position where the second horizontal part extends ahead of the base horizontally from the first horizontal part assuming the downwardly extending position and a horizontal forward position where the second horizontal part extends ahead of the base horizontally from the first horizontal part assuming the horizontal position.

In the above-described construction, an imaging distance from the camera head to the material on the base installation surface is longer by the spacing between the first and second support shafts when the first horizontal part assumes the horizontal position and the second horizontal part assumes the horizontal forward position than when the first horizontal part assumes the downwardly extending position and the second horizontal part assumes the horizontal backward position. Consequently, the imaging area of the camera head can be enlarged.

Moreover, the location of the camera head is moved forward by the spacing between the first and second support shafts upon enlargement of the imaging area of the camera head. Consequently, the base front can be prevented from being imaged together with the material.

In an embodiment, the second horizontal part is mounted on the second support shaft further mounted on the first horizontal part, so as to be pivotable from the horizontal backward position to a downwardly extending position where the second horizontal part extends downward in parallel with the upright part. The visual presenter can be folded into a compact form since the first and second horizontal parts extend in parallel with the upright part of the support column.

In another embodiment, the upright part is mounted on a third support shaft further mounted on the base, so as to be pivotable between a first position where the upright part stands upright on the base and a second position where the upright part lies horizontally relative to the base. The first and second horizontal parts extend in parallel with the upright part of the support column, and the upright part and the first and second horizontal parts all lie horizontally relative to the base while extending in parallel with each other. Consequently, the visual presenter can be folded into a more compact form.

### BRIEF DESCRIPTION OF THE DRAWINGS

FIG. 1 is a perspective view of a visual presenter in accordance with one embodiment of the present invention, in which view a first horizontal part is set to a horizontal position;

FIG. 2 is a perspective view of the visual presenter, in which view the first horizontal part is set to a downwardly extending position;

FIG. 3 is a perspective view of the visual presenter with the first and second horizontal parts being in parallel with the upright part;

FIG. 4 is a side view of the visual presenter in the case where the upright part and the first and second horizontal parts are laid down on the base;

FIG. 5 is a side view of the visual presenter with the first horizontal part being set to a downwardly extending position;

FIG. 6 is a plan view of the visual presenter with the first horizontal part being set to the downwardly extending position;

FIG. 7 is a side view of the visual presenter with the first horizontal part being set to a horizontal position;

FIG. 8 is a plan view of the visual presenter with the first horizontal part being set to a horizontal position;

FIG. 9 is a perspective view of a conventional visual presenter; and

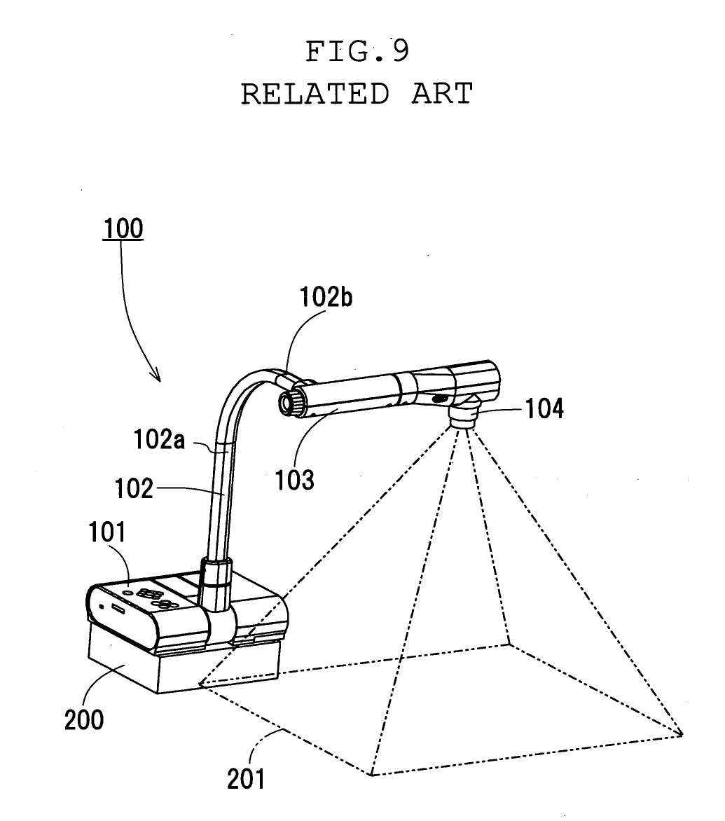

FIG. 10 is a side view of the conventional visual presenter.

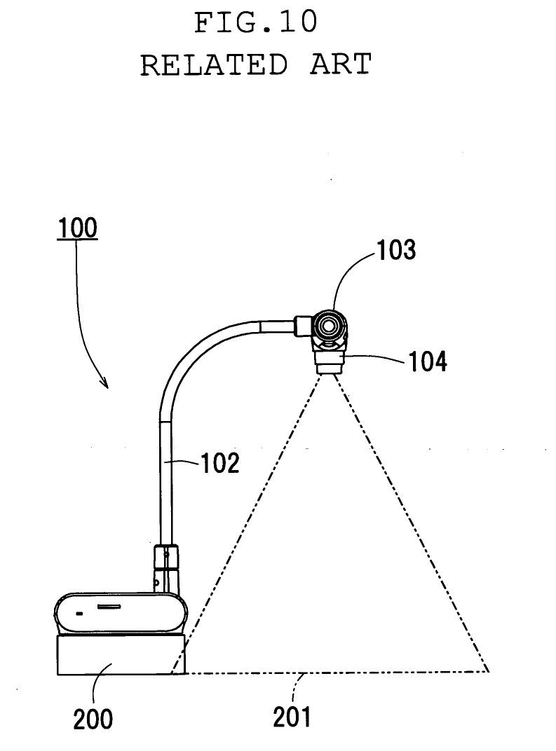

### DETAILED DESCRIPTION

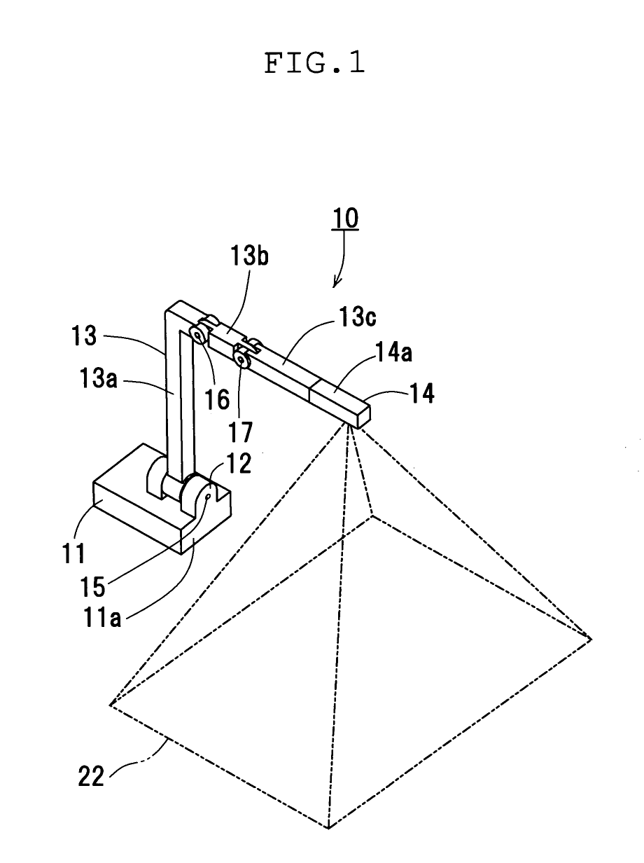

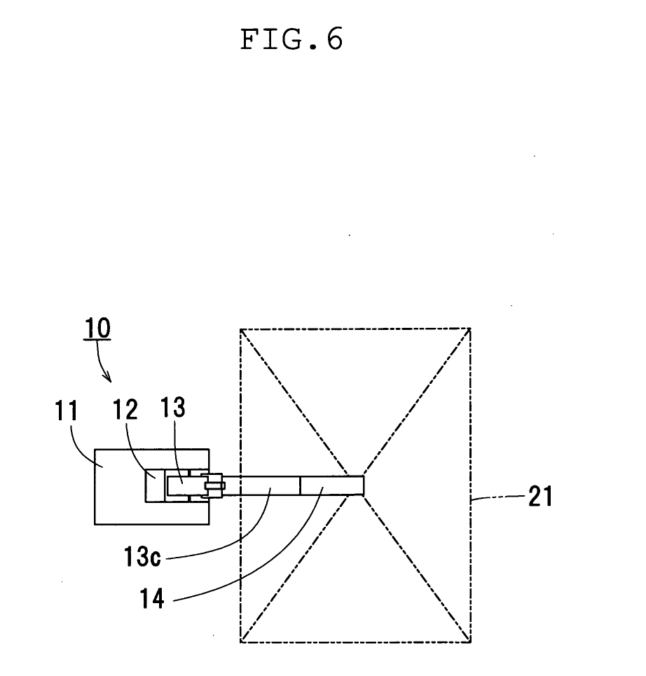

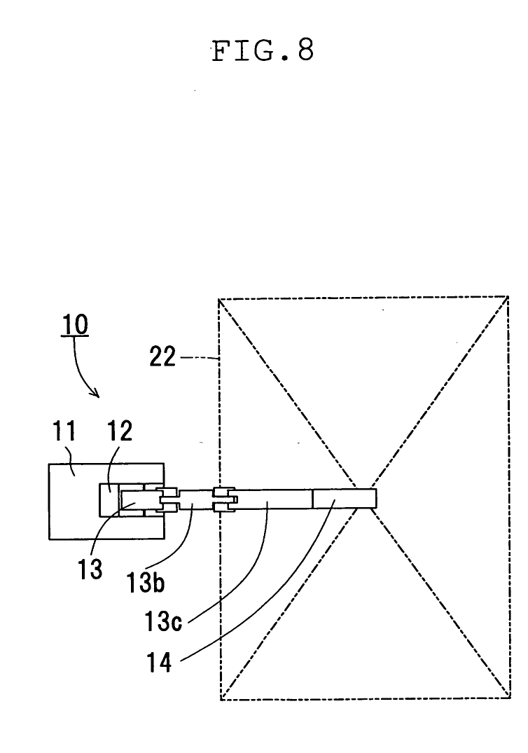

One embodiment of the present invention will be described with reference to FIGS. 1 to 8 of the accompanying drawings. Referring to FIG. 1, a visual presenter of the embodiment is shown. The visual presenter 10 includes a base 11, a pedestal 12, a support column 13 and a camera head 14. The base 11 is generally rectangular in planar shape and includes a front 11a on which the pedestal 12 is mounted. A control circuit unit (not shown) is incorporated in the base 11. The base 11 has a rear (not shown) provided with terminals which are used to connect the visual presenter 10 to a TV monitor, a video projector 10 and the like.

The support column 13 has a hollow construction and is composed of an upright part 13a, a first horizontal part 13b extending ahead of the base 11 horizontally from an upper end of the upright part 13a, and a second horizontal part 13c extending ahead of the base 11 horizontally from the first horizontal part 13b. Wire harnesses (not shown) are inserted through the support column 13 to connect between the control circuit unit incorporated in the base 11 and the camera head 14.

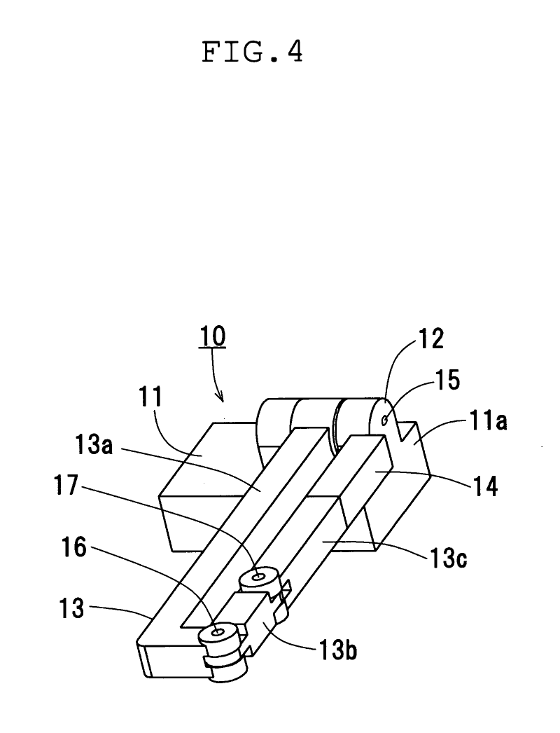

The upright part 13a of the support column 13 is mounted on a support shaft (a third support shaft) 15 further mounted on the pedestal 12, so as to be pivotable between a first position where the upright part 13a stands upright on the base 11 as shown in FIGS. 1 to 3 and a second position where the upright part 13a lies horizontally relative to the base 11 as shown in FIG. 4.

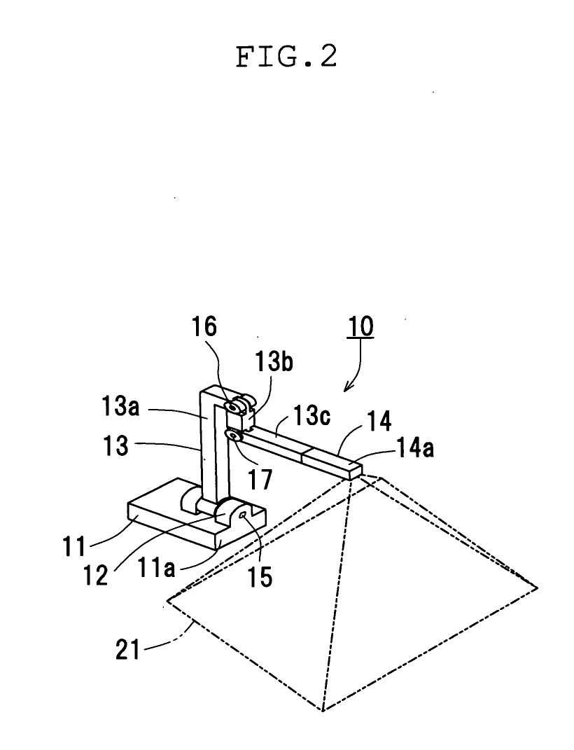

The first horizontal part 13b is mounted on a first support shaft 16 further mounted on an upper end of the upright part 13a, so as to be pivotable between a horizontal position where the first horizontal part 13b extends ahead of the base 11 horizontally from the upright part 13a as shown in FIG. 1 and a downwardly extending position where the first horizontal part 13b extends downward in parallel with the upright part 13a as shown in FIG. 2.

The second horizontal part 13c is mounted on a second support shaft 17 further mounted on an end of the first horizontal part 13b located opposite the first support shaft 16 side, so as to be pivotable between a horizontal forward position where the second horizontal part 13c extends ahead of the base horizontally from the first horizontal part 13b located at the horizontal position as shown in FIG. 1 and a horizontal backward position where the second horizontal part 13c extends ahead of the base 11 horizontally from the first horizontal part 13b located at the downwardly extending position as shown in FIG. 2.

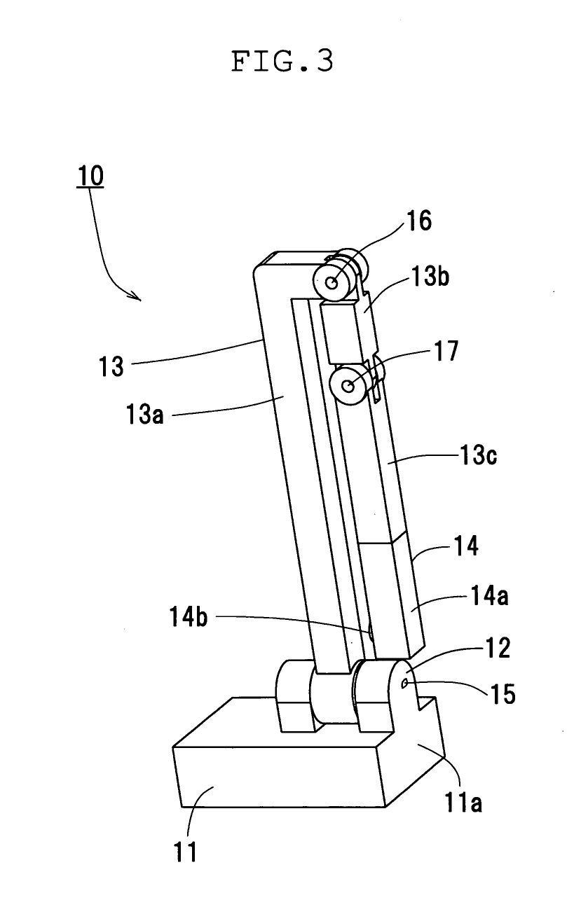

The second horizontal part 13c is also mounted on the second support shaft 17 further mounted on the first horizontal part 13b, so as to be pivotable from the horizontal backward position as shown in FIG. 2 to a downwardly extending position where the second horizontal part 13c extends downward in parallel with the upright part 13a as shown in FIG. 3.

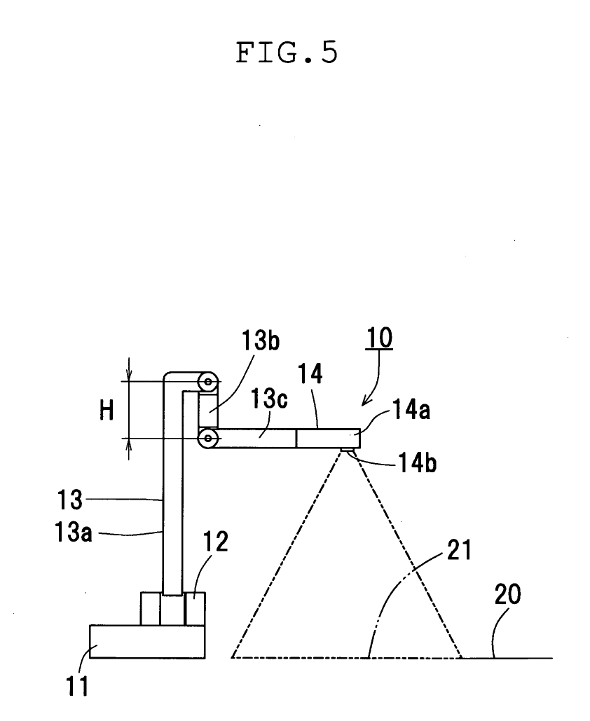

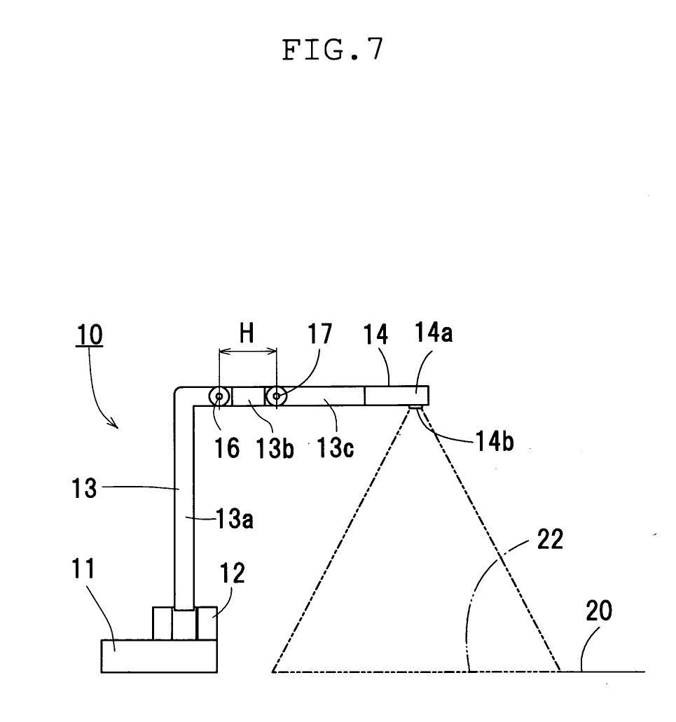

The camera head 14 has a generally rectangular parallelepiped housing 14a which is fixed to a front end of the horizontal part 13c so as to align linearly with the horizontal part 13c and extends forward. A lens tube 14b (see FIGS. 5 and 7) into which an imaging lens group is built protrudes downward from a lower surface of the front end of the housing 14a. A camera control circuit (not shown) is incorporated in the housing 14a. A balancer (not shown) with a predetermined weight is provided in the base 11 in order that the visual presenter 10 may be prevented from falling ahead of the base 11 by the weight of the camera head 14.

A usage of the visual presenter 10 as constructed above will now be described as follows. Firstly, the first horizontal part 13b of the support column 13 is set to the downwardly extending position, and the second horizontal part 13c of the support arm 13 is set to the horizontal backward position. A material is then placed on the base installation surface 20 (see FIG. 5), and the position of the material is adjusted so as to be fit into the imaging area 21.

In the case where the size of the material is so large that the entire material cannot be imaged even when a field angle of the imaging lens is set to a widest angle, the first horizontal part 13b is set to the horizontal position, and the second horizontal part 13c is set to the horizontal forward position, as shown in FIGS. 1, 7 and 8. As the result of this setting, the distance between the base installation surface 20 and the imaging lens set to the widest angle is increased by the spacing H between the first and second support shafts 16 and 17, whereby the imaging area 22 can be enlarged.

When the visual presenter 10 is not used, the first and second horizontal parts 13b and 13c of the support column 13 are juxtaposed to the upright part 13a, and the juxtaposed upright part 13a and the first and second horizontal parts 13b and 13c are laid horizontally relative to the base 11 and folded.

According to the foregoing embodiment, an imaging distance from the camera head 14 to the material on the base installation surface 20 is longer by the spacing H between the first and second support shafts 16 and 17 when the first horizontal part 13b assumes the horizontal position and the second horizontal part 13c assumes the horizontal forward position than when the first horizontal part 13b assumes the downwardly extending position and the second horizontal part 13c assumes the horizontal backward position. Consequently, the imaging area of the camera head 14 can be enlarged.

Moreover, the location of the camera head is moved forward by the spacing H between the first and second support shafts 16 and 17 upon enlargement of the imaging area of the camera head 14. Consequently, the base front can be prevented from being imaged together with the material.

Furthermore, the first and second horizontal parts 13b and 13c are juxtaposed to the upright part 13a, and the upright part 13a and the first and second horizontal parts 13b and 13c are laid horizontally relative to the base 11. Consequently, the visual presenter 10 can be folded into a more compact form.

The foregoing description and drawings are merely illustrative of the principles and are not to be construed in a limiting sense. Various changes and modifications will become apparent to those of ordinary skill in the art. All such changes and modifications are seen to fall within the scope as defined by the appended claims.

What is claimed is:

1. A visual presenter comprising:
a base; and
a column support standing on the base and having a distal end on which a camera head is located, the column support including an upright part standing upright from the base and a horizontal part that is continuous from the upright part and extends horizontally ahead of the base, the distal end of the column support corresponding to a distal end of the horizontal part, the camera head being mounted on the distal end of the horizontal part and adapted to image a material placed on an installation surface for the base, wherein:
the horizontal part includes a first horizontal part and a second horizontal part;
the first horizontal part is mounted on a first support shaft further mounted on an upper end of the upright part, so as to be pivotable between a downwardly extending position where the first horizontal part extends downward in parallel with the upright part and a horizontal position where the first horizontal part extends ahead of the base horizontally from the upright part; and
the second horizontal part is mounted on a second support shaft further mounted on an end of the first horizontal part located opposite the first support shaft side, so as to be pivotable between a horizontal backward position where the second horizontal part extends ahead of the base horizontally from the first horizontal part assuming the downwardly extending position and a horizontal forward position where the second horizontal part extends ahead of the base horizontally from the first horizontal part assuming the horizontal position.

2. The visual presenter according to claim 1, wherein the second horizontal part is mounted on the second support shaft further mounted on the first horizontal part, so as to be pivotable from the horizontal backward position to a downwardly extending position where the second horizontal part extends downward in parallel with the upright part.

3. The visual presenter according to claim 2, wherein the upright part is mounted on a third support shaft further mounted on the base, so as to be pivotable between a first position where the upright part stands upright on the base and a second position where the upright part lies horizontally relative to the base.
